(19) United States
(12) Patent Application Publication
(10) Pub. No.: US 2025/0158544 A1
(43) Pub. Date: May 15, 2025

(54) MULTI-MOTOR CONVERTER

(71) Applicant: ebm-papst Mulfingen GmbH & Co. KG, Mulfingen (DE)

(72) Inventors: Georg Wiedmann, Langenburg (DE); Benedikt Stoll, Elztal-Neckarburken (DE)

(21) Appl. No.: 18/947,242

(22) Filed: Nov. 14, 2024

(30) Foreign Application Priority Data
Nov. 14, 2023 (DE) 10 2023 131 705.9

(51) Int. Cl. H02P 5/50; H02P 21/18; H02P 21/22

(52) U.S. Cl. CPC H02P 5/50; H02P 21/18; H02P 21/22

(57) ABSTRACT

A regulation system has a multi-motor converter (PWR) for the controlled parallel operation of a number of n EC motors (M1, . . . , Mn), the respective rotor position of which is detected without the use of sensors and is controlled by the common converter.

The invention relates to a sensorless multi-motor converter for parallel operation of at least two, in particular multiple motors, and to a regulation method for operating the two or multiple motors on a common multi-motor converter.

For operation of an electrically commutated motor (PMSM/EC motor) on a converter, which is not based on sensors or rotor position sensors, the voltages applied to the terminals of the motor as well as the currents flowing in the motor phases are usually detected and evaluated in a suitable manner in order to determine the rotor position and commutate the motor accordingly. However, there is no satisfactory solution known in the prior art to operate two or more such motors (PMSM/EC motor) with a single converter. When motors are mentioned in the following description, sensorless controlled PMSM motors or sensorless controlled EC motors are meant.

A publication is known from KR 101 687 556 B1, which refers to a motor drive device for two motors. The motor drive device according to an embodiment of this document comprises an inverter which comprises a number of suitable switching elements and supplies alternating current to a first motor and a second motor by converting direct current into alternating current by switching the switching elements, and a control unit which controls the inverter. The control unit sets a magnetic flux current target value according to a speed difference or a phase difference of the first motor and the second motor, and controls the inverter based on a switching control signal based on the set magnetic flux current target value. Accordingly, a speed error can be reduced if multiple motors connected in parallel are controlled simultaneously.

DE 10 2018 124 209 A1 describes another concept of the present applicant. In order to avoid repetition of individual structural components, it is pointed out that a person skilled in the art already knows this information from this publication. A basic idea of the concept described therein is that for parallel operation of multiple, i.e. at least two, electrically commutated motors on a common converter without the need for a rotor position sensor, the phase currents are detected separately for each of the connected motors. In addition, however, only a single voltage detection is required per converter output phase, since the parallel operation of the motors means that the same terminal voltage is applied to all motors. Alternatively, it is also conceivable that the terminal voltage is not detected but can be calculated from the control levels output by the regulator.

A significant difference between the multi-motor converter according to the invention and a conventional converter is the detection and processing of the measurement signals for determining the rotor position of multiple motors, wherein a separate current detection is carried out for each motor connected to the multi-motor converter. Furthermore, DE 10 2018 124 209 A1 describes a method for operating multiple EC motors in parallel on the common multi-motor converter, in which the following steps are used: detecting the individual phase currents and the terminal voltage of the EC motors, determining the rotor positions and speeds using the previously measured characteristic variables, generating and transmitting current and/or voltage variables in a space vector representation or in d-q space vector coordinates using the previously determined rotor positions and speeds to the regulation device and generating three-phase voltage variables by means of a Clarke-Park transformation from the current and/or voltage variables in space vector representation and passing these on to a modulator. From this, switching commands are generated for the multi-motor converter to operate the multiple EC motors in parallel.

It is therefore an object of the present invention to provide an alternative solution for operating multiple motors on one converter, which can be implemented cost-effectively and used as universally as possible.

The problem of the invention is solved by the features of claim 1.

A basic idea of the invention is that for parallel operation of multiple, at least two, electrically commutated motors on a common converter without the need for a rotor position sensor, a separate determination of the rotor position is carried out for each of the motors (PMSM/EC motor). This is possible due to the current measurements carried out separately for each motor on the converter, e.g. using one of the numerous known methods for sensorless rotor position determination. The advantage is that each motor can be described individually for regulation purposes in its own individual coordinate system (KOS).

Another aspect concerns the fact that by adding the corresponding motor currents of the EC motors, the summed currents in the converter can be determined, with the benefit of determining the coordinate system of the converter.

In a preferred embodiment of the regulation method described here as an example, the coordinate system of a master motor is used as a reference coordinate system. One of the motors is used as the master motor, while the other motors do not have the function of the master motor.

However, any of the other coordinate systems (KOS), or alternatively a suitable fictitious coordinate system (KOS), can also act as a reference system, which is specified as such in the system.

According to the invention, two alternative regulation concepts are implemented. On the one hand, regulation with a nonlinear and alternatively with a linear state-space regulator. Both variants are suitable for implementing the inventive idea.

Regulation with a Nonlinear State-Space Regulator

The regulation of the multi-motor system can be achieved by a regulator implementation with a nonlinear state-space regulator in the state-space. The regulation can be carried out on the basis of the nonlinear differential equations of the machine equations. Furthermore, according to a preferred embodiment of the invention, a stabilization regulator is additionally required in order to return the motors to a stable operating point after a load jump by injecting a d-current.

Regulation with a Linear State-Space Regulator

The regulation of the multi-motor system does not have to be carried out on the basis of the nonlinear motor differential equations, namely the machine equations. Alternatively, a linearization of the differential equations can be carried out at an arbitrarily selectable operating point. The advantage of linear state-space regulation is that linearization simplifies regulator design. The regulator can now be calculated according to the design variants for linear state-space regulation known to the skilled in the art.

Due to the presence of multiple motors and thus also multiple coordinate systems for the respective motors, it is necessary to determine a reference coordinate system for the commutation of the converter in a suitable manner. In the regulation method described herein, the coordinate system of the master motor is used as the reference coordinate system. However, any of the other coordinate systems, or even a suitable fictitious KOS, can also act as a reference system.

A further aspect of the present invention relates to a method for operating n EC motors (with n≥2, namely with at least two EC motors) in parallel operation on a common multi-motor converter, in particular with a regulation system as described above, with the following steps:
a. separate detecting of the individual phase currents I_{M1}, . . . , I_{Mn} of the n EC motors,
b. determining the rotor positions and speeds of the n EC motors using the previously measured phase currents I_{M1}, . . . , I_{Mn} of the n EC motors in order to determine a separate, in particular independent coordinate system (KOS) for each of the n EC motors;
c. generating and transmitting current and/or voltage variables in a space vector representation to the regulation device based on the values of the determined rotor positions determined in step b),
d. generating three-phase voltage variables U_{uvw} by means of a Clarke-Park transformation from the voltage variables in space vector representation and passing these on to a modulator;
e. generating switching commands using the modulator from the voltage variables U_{uvw} for the multi-motor converter to control the operation of the n EC motors,
f. wherein the regulation of the n EC motors is carried out by the converter in relation to a selected reference motor and its reference coordinate system.

Other advantageous developments of the invention are characterized in the dependent claims and will be described in greater detail in the following, in conjunction with the description of the preferred embodiment of the invention, with reference to the figures. In the figures:

FIG. 1 shows a block diagram of a regulation system according to a first embodiment of the invention designed as a regulation with a nonlinear or linear state-space regulator R;

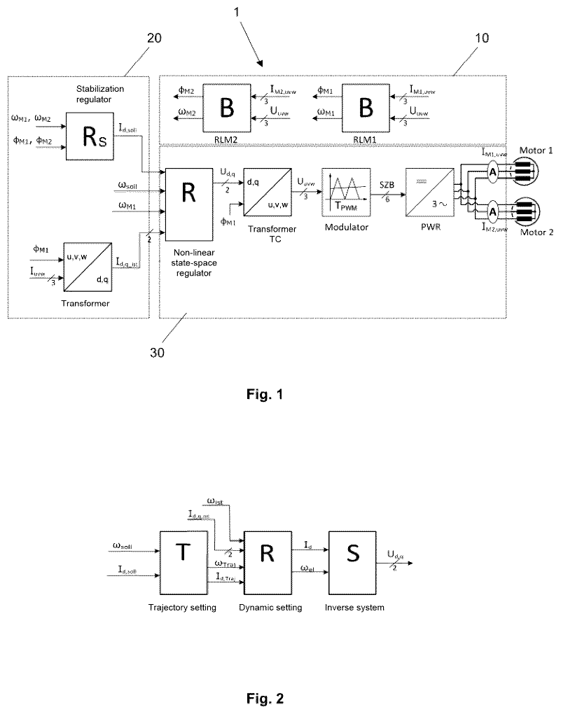

FIG. 2 shows a block diagram of a nonlinear state-space regulator R which results in the following block diagram,

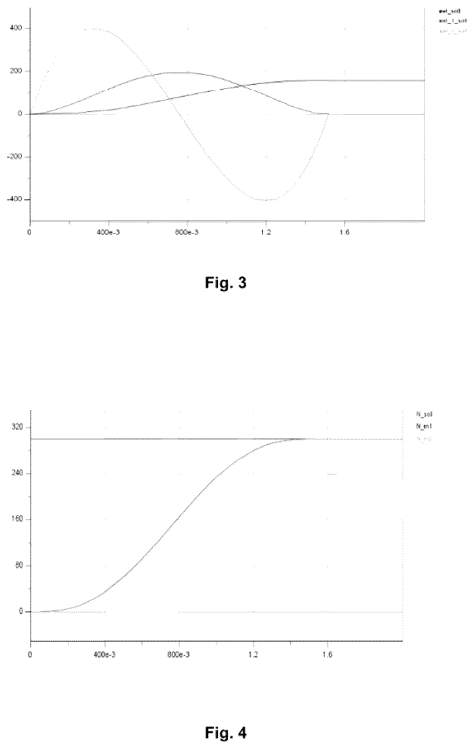

FIG. 3 shows an exemplary trajectory specification for speed,

FIG. 4 shows a curve showing the transient response of speed of the two motors M1 and M2,

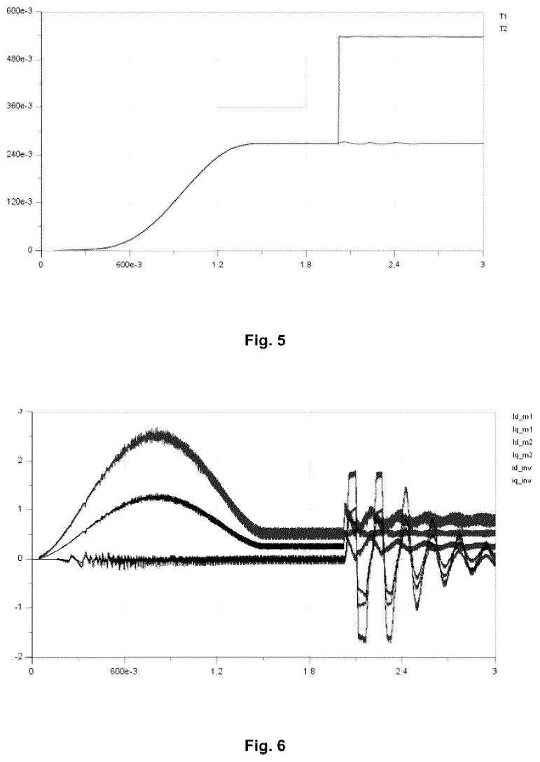

FIG. 5 shows the torque change after a load step,

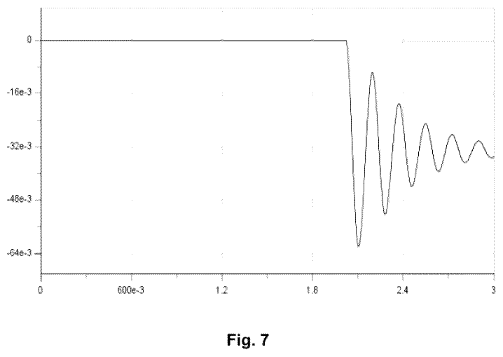

FIG. 6 shows the field-oriented current evolution in regulated operation by means of the stabilization regulator,

FIG. 7 shows the angle difference between the two motors in regulated operation.

The invention will be explained in greater detail below based on two embodiments with reference to FIG. 1, wherein the same reference numerals are used to denote the same functional and/or structural features.

The two embodiments can be represented equally by FIG. 1, since the difference lies in the state-space regulator R, which is designed either as a nonlinear state-space regulator R (as shown) or alternatively as a linear state-space regulator R. FIG. 1 shows a regulation system 1 comprising a multi-motor converter PWR for the regulated parallel operation of a number of n EC motors M1, M2 (here with n=2), whose respective rotor positions are each detected sensorless.

For this purpose, a detection device 10 with rotor position detectors RLM₁, RLM₂ is provided for determining at least the rotor positions ϕ_{M1}, ϕ_{M2} and speeds ω_{M1} and ω_{M2} of the two EC motors (M1, M2) based on the previously measured phase currents I_{M1}, I_{M2} and the terminal voltage U_{u,v,w} of the two EC motors. The detection device 10 is further designed to receive the total current I_{uvw}, wherein the total current I_{uvw}=I_{M1}+I_{M2} and is used as an input variable for determining the variables rotor position φ_{U} and speed ω_{U} in addition to the terminal voltage U_{uvw}.

Thus, the detection device 10 has the devices RLM1, RLM2, which are designed to determine the rotor positions and the respective rotation speed ω_{M1}, ω_{M2} of the two motors M1, M2.

Furthermore, in both embodiments, a regulation and transformation device 20 is provided in order to generate a corresponding d-current I_{d,Soll} in the d-q coordinate system with the aid of the determined rotor positions and the speeds for regulating the two motors via a stabilization regulator RS and to supply it as a target specification to the linear or non-linear state regulator R or to impress it for stabilization in order to bring the two motors (as shown in FIG. 5) back to a stable operating point. Furthermore, a transformer T is provided. The regulation and transformation device 20 preferably has a Clarke-Park transformer for transforming the detected variables rotor position and total current I_{uvw} into a d-q current variable I_{d,q_ist} in space vector representation for the regulation device 30.

Thus, an I_{dq,Ist} current is supplied as an input variable to the non-linear or linear state regulator R of the regulation device 30. In addition to the determined speed, the target speed ω_{Soll} is also impressed or fed to the state regulator R as a regulation variable.

FIG. 2 shows a block diagram of a non-linear state-space regulator R. A mathematical function for the starting behavior of the speed and the current id is implemented via the trajectory setting, which is used as a defined dynamic setting for the target change of the state-space regulator. This dynamic setting reduces the target error between the target and actual value and thus regulates the system. The inverse system then serves to convert the calculated regulation variables id and ωₑₗ into the voltage variables Ud and Uq to be set on the basis of the system differential equations.

FIG. 3 shows an exemplary speed trajectory. A corresponding trajectory setting is used as an input variable for the nonlinear state-space regulator R. In addition to the actual values for speed and I_{dq} current, additional default values for speed and current are entered into the state-space regulator R via the trajectory setting. By setting the trajectory, the system is given a starting dynamic. The dynamics of the control loop can be adjusted based on the eigenvalues of the system or freely selected pole points. This corresponds to the standard design method for state-space regulators found in the literature. The change in the target values is then passed on to the inverse system, which calculates the terminal voltages U_{d,q} to be applied on the basis of the variables specified by the regulator.

The regulation device 30 also generates switching commands SZB for the multi-motor converter PWR to operate the two motors M1, M2.

As already explained, the trajectory of the rotation frequency can be seen in FIG. 3. A speed of 300 rpm is reached in a time of 1.5 seconds. Based on the given target trajectory, the state regulator R now regulates the speed to the desired target value.

FIG. 4 shows the transient response of the speed of both motors M1, M2. After approximately 2 seconds of simulation time, the steady-state system is excited with the load step shown. The torque on motor 1 is doubled, which is shown in FIG. 5. The stabilization regulator now intervenes by injecting a d-current (as explained in FIG. 6) and brings the two motors M1, M2 back to a stable operating point, which is shown in FIG. 7.

The diagram of the angle difference in FIG. 7 shows that the system stabilizes after the load jump with a remaining angle difference. Before the load jump, the angle difference in the steady state is close to zero. After the load jump, there is a deviation of about 0.03 radians, which corresponds to about 1.71 degrees. The deviation is within the expected range, since the coordinate systems of the motors rotate slightly against each other due to the different loads.

In the alternative embodiment with a linear state-space regulator, reference can in principle be made to FIGS. 1, 3-7, since the resulting behavior of the multi-motor system is in principle comparable. The angle of the rotor position determination RML1 is used as the reference coordinate system. On the one hand, the regulator works on the basis of a d-current target specified by the stabilization regulator in FIG. 1. Such a regulator can, for example, correspond to the concept from DE 10 2018 124 209 A1.

The target rotation frequency can be specified by a trajectory specification or alternatively by a fixed target value. The state regulator R then sets the appropriate voltages based on the measured d-current and the measured rotation frequency. The switching commands are then sent to the converter via Clarke-Park transformation and a subsequent PWM modulator.

The linearly regulated system also responds well to the applied load jump after about two seconds. The stabilization regulator also intervenes by injecting a d-current and brings the two machines back to a stable operating point (see FIG. 7). However, the linearized regulator does not manage to reduce the d-component of the motor current to zero. Furthermore, the regulated current has a slightly higher ripple with the same system dynamics.

The invention is not limited in its form to the preferred exemplary embodiments provided above. Rather, a number of variants is conceivable, which make use of the presented solution even with fundamentally different designs.

1. A regulation system comprising a multi-motor converter (PWR) for the controlled parallel operation of a number of n EC motors (M1, . . . , Mn), the respective rotor position of which is detected without the use of sensors, where n≥2, comprising
a. at least one detection device for separately determining at least the rotor positions and speeds of the n EC motors (M1, . . . , Mn) by means of previously measured phase currents I_{M1}, . . . , I_{Mn} with separately executed current detections and optionally the terminal voltage U_{u,v,w} of the n EC motors (M1, . . . , Mn) at the converter, wherein each of the n EC motors (M1, . . . , Mn) is described for regulation in its own coordinate system (KOS),
b. a regulation and transformation device comprising a stabilization regulator (RS) which generates a d-current from the determined rotor positions and speeds of the n-motors,
c. a regulation device connected downstream of the regulation and transformation device and having a linear or non-linear state regulator (R) to which the current variables output by the regulation and transformation device are fed in order to generate switching commands (SZB) for the multi-motor converter for operating the n motors.

2. The regulation system according to claim 1, characterized in that a trajectory setting or a fixed target value is used for the speed setting to the state regulator (R).

3. The regulation system according to claim 1, characterized in that the detection device RLM1, RLM2 has at least one measuring device for sensorless detection of the respective phase currents I_{M1}, . . . , I_{Mn} of the n EC motors (M1, . . . , Mn).

4. The regulation system according to claim 1, characterized in that the regulation and transformation device has a Clarke-Park transformer (TP) for transforming at least the variables rotor position and total current I_{uvw} into a d-q current variable I_{d,q_ist} in space vector representation for the regulation device.

5. The regulation system according to claim 1, characterized in that the regulation device has a Clarke-Park transformer (TC), for transforming the voltage variables U_{d,q} obtained from the state-space regulator (T) in space vector representation by means of Clarke-Park transformation into a three-phase voltage variable U_{uvw} and for converting these into direct voltage switching signals (SZB) for the converter (PWR) by means of a PWM modulator (PWM).

6. The regulation system according to claim 1, characterized in that the stabilization regulator (R) is provided for providing a suitable current variable I_{d_SOLL} in order to impress this current variable on the state regulator in order to return the motors to a stable operating point after a load jump in one of the EC motors.

7. The regulation system according to claim 1, characterized in that the regulation device has a Clarke-Park transformer (TC) for transforming the voltage variables U_{d,q} obtained from the state-space regulator (R_{dq}) in space vector representation by means of Clarke-Park transformation into a three-phase voltage variable U_{uvw} and for converting these into switching signals (SZB) for the converter (PWR) by means of a PWM modulator (PWM).

8. A method for operating n EC motors with n≥2 in parallel operation on a common multi-motor converter (PWR) with a regulation system according to claim 1, comprising the following steps:
a. separate detecting of the individual phase currents I_{M1}, . . . , I_{Mn} of the n EC motors (M1, . . . , Mn),
b. determining the rotor positions and speeds of the n EC motors (M1, . . . , Mn) using the previously measured phase currents I_{M1}, . . . , I_{Mn} of the n EC motors in order to determine a separate, in particular independent coordinate system (KOS) for each of the n EC motors (M1, . . . , Mn);
c. generating and transmitting current and/or voltage variables in a space vector representation to the regulation device based on the values of the determined rotor positions determined in step b),
d. generating three-phase voltage variables U_{uvw} by means of a Clarke-Park transformation from the voltage variables in space vector representation and passing these on to a modulator (PWM);
e. generating switching commands (SZB) using the modulator (PWM) from the voltage variables U_{uvw} for the multi-motor converter (PWM) to control the operation of the n EC motors,
f. wherein the regulation of the n EC motors is carried out in relation to a selected reference motor and its reference coordinate system.
